(19) United States
(12) Patent Application Publication
(10) Pub. No.: US 2023/0066421 A1
(43) Pub. Date: Mar. 2, 2023

(54) IMAGE FORMING APPARATUS

(71) Applicant: FUJIFILM Business Innovation Corp., Tokyo (JP)

(72) Inventors: Naoya KAMIGAITO, Kanagawa (JP); Shohei MIYAGAWA, Kanagawa (JP); Satoshi MATSUZAKA, Kanagawa (JP); Mitsuaki KURODA, Kanagawa (JP)

(73) Assignee: FUJIFILM Business Innovation Corp., Tokyo (JP)

(21) Appl. No.: 17/573,692

(22) Filed: Jan. 12, 2022

(30) Foreign Application Priority Data
Aug. 25, 2021 (JP) 2021-137598

(51) Int. Cl. G03G 15/00

(52) U.S. Cl. CPC G03G 15/657; G03G 15/6567; G03G 15/6564

(57) ABSTRACT

An image forming apparatus includes: a forming part that forms an image on a recording medium; a fixing part that fixes the image formed on the recording medium; a revolving part having a revolving member stretched over multiple rotary members, the revolving member revolving between the forming part and the fixing part to transport the recording medium from the forming part to the fixing part; a feed part that feeds the recording medium to the forming part; a discharge part that discharges the recording medium to which the image has been fixed in the fixing part; a branch part that is provided so as to be split from the discharge part and along which the recording medium, to one side of which the image has been fixed, is transported to the feed part after switching the leading end and the trailing end of the recording medium; a first housing accommodating the forming part, the fixing part, and the revolving part; and a second housing connected to the first housing and accommodating the feed part, the discharge part, and the branch part.

### CROSS-REFERENCE TO RELATED APPLICATIONS

This application is based on and claims priority under 35 USC 119 from Japanese Patent Application No. 2021-137598 filed Aug. 25, 2021.

### BACKGROUND

### (i) Technical Field

The present disclosure relates to an image forming apparatus.

### (ii) Related Art

Japanese Unexamined Patent Application Publication No. 2012-140242 discloses a printed-material transport device including: a first transport mechanism that can horizontally transport a printed material at a first speed while supporting the lower surface of the printed material with a revolving belt member; a second transport mechanism that is disposed downstream of the first transport mechanism in a printed-material transport direction such that a predetermined distance of a parallel transport section is formed and that can horizontally transport the printed material at a second speed, which is lower than the first speed, while holding the printed material with a jaw mechanism; and a jaw opening/closing mechanism that closes the jaw mechanism, which is open in the parallel transport section, at a predetermined gripping position and opens the jaw mechanism at a predetermined releasing position in a transport section with the second transport mechanism on the downstream side of the parallel transport section.

### SUMMARY

Aspects of non-limiting embodiments of the present disclosure relate to simplifying the adjustment among a forming part, a transport part, and a fixing part at the time of installation of an image forming apparatus, compared with a configuration in which any of the forming part, the transport part, and the fixing part is disposed in a housing other than the housing of the others.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a forming part that forms an image on a recording medium; a fixing part that fixes the image formed on the recording medium; a revolving part having a revolving member stretched over multiple rotary members, the revolving member revolving between the forming part and the fixing part to transport the recording medium from the forming part to the fixing part; a feed part that feeds the recording medium to the forming part; a discharge part that discharges the recording medium to which the image has been fixed in the fixing part; a branch part that is provided so as to be split from the discharge part and along which the recording medium, to one side of which the image has been fixed, is transported to the feed part after switching the leading end and the trailing end of the recording medium; a first housing accommodating the forming part, the fixing part, and the revolving part; and a second housing connected to the first housing and accommodating the feed part, the discharge part, and the branch part.

### BRIEF DESCRIPTION OF THE DRAWINGS

Exemplary embodiment of the present disclosure will be described in detail based on the following figures, wherein:

FIG. 1 is a front sectional view showing the configuration of an image forming apparatus according to an exemplary embodiment;

FIG. 2 is a front sectional view of a housing of the image forming apparatus according to the exemplary embodiment;

FIG. 3 is a front sectional view of another housing of the image forming apparatus according to the exemplary embodiment;

FIG. 4 is a front view of the image forming apparatus according to the exemplary embodiment;

FIG. 5 is a plan view of the image forming apparatus according to the exemplary embodiment;

FIG. 6 is a perspective view of a joint part according to the exemplary embodiment;

FIG. 7 is a perspective view of the joint part according to the exemplary embodiment;

FIG. 8 is a perspective view of the joint part according to the exemplary embodiment;

FIG. 9 is a perspective view of the joint part according to the exemplary embodiment;

FIG. 10 is a perspective view of the joint part according to the exemplary embodiment;

FIG. 11 is a perspective view of the joint part according to the exemplary embodiment;

FIG. 12 is a plan view of a measurement part according to the exemplary embodiment;

FIG. 13 is a front view of a position adjusting part according to the exemplary embodiment;

FIG. 14 is a perspective view of a chain gripper according to the exemplary embodiment;

FIG. 15 is a perspective view showing the configuration around an image forming position in the image forming apparatus according to the exemplary embodiment; and

FIG. 16 is a perspective view of the fixing part according to the exemplary embodiment.

### DETAILED DESCRIPTION

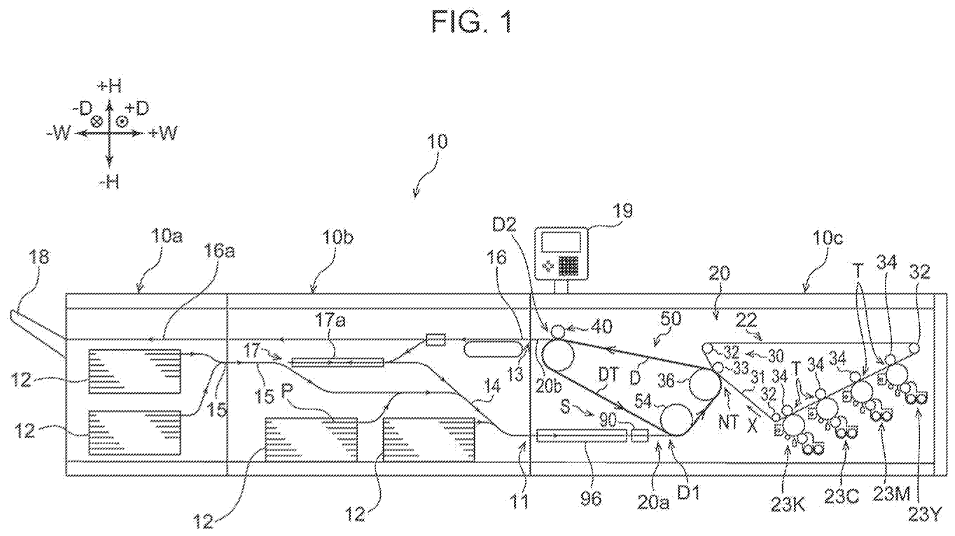

An image forming apparatus 10 according to an exemplary embodiment of the present disclosure will be described below with reference to FIGS. 1 to 16.

In the description below, the vertical direction of the apparatus (height direction), the width direction of the apparatus (horizontal direction), and the depth direction of the apparatus (horizontal direction) when the image forming apparatus 10 is viewed from the front, where a user (not shown) stands, will be referred to as the H direction, the W direction, and the D direction, respectively. When one side and the other side of the vertical direction, the width direction, and the depth direction need to be distinguished, the upper side, the lower side, the right side, the left side, the far side, the and near side in front view of the image forming apparatus 10 will be referred to as the +H side, the −H side, the +W side, the −W side, the −D side, the and +D side, the respectively.

### Image Forming Apparatus

An image forming apparatus 10 according to this exemplary embodiment is an electrophotographic image forming apparatus, in which a toner image is formed on a sheet member P, serving as a recording medium. As shown in FIG. 1, the image forming apparatus 10 includes storage parts 12, a first feed part 14, a second feed part 15, an image forming unit 20, a discharge part 16, a branch part 17, an output part 18, and a controller 19 that controls these components.

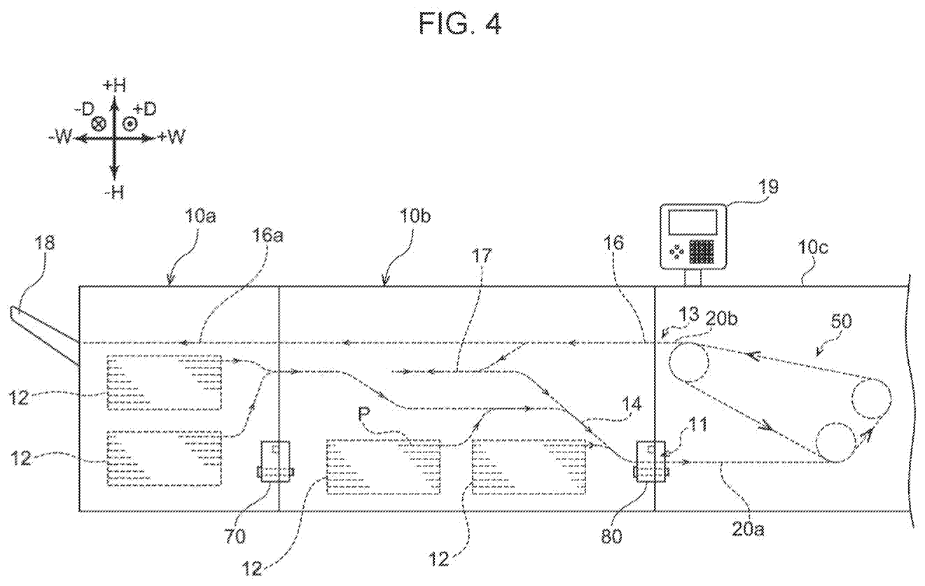

The image forming apparatus 10 further includes an apparatus body accommodating these components. The apparatus body includes three substantially rectangular-parallelepiped-shaped housings joined to one another in the width direction. The three housings include a housing 10a, a housing 10b, and a housing 10c, in this order from the −W side. The housing 10c accommodates the image forming unit 20. The housing 10b accommodates the first feed part 14, the second feed part 15, the discharge part 16, and the branch part 17. The details of the housings 10a, 10b, and 10c will be described below. As shown in FIG. 4, the image forming apparatus 10 also includes first joint parts 70 for joining the housing 10a and the housing 10b together, and second joint parts 80 for joining the housing 10b and the housing 10c together.

The image forming apparatus 10 further includes a measurement part 96 that measures the dimensions of a sheet member P transported toward a forming part 22 (described in detail below) of the image forming unit 20, and a position adjusting part 90 that adjusts the position of the sheet member P.

### Storage Part

The storage parts 12 accommodate sheet members P. The image forming apparatus 10 includes four storage parts 12. Sheet members P are selectively fed out from the four storage parts 12.

In this exemplary embodiment, two storage parts 12 are disposed in the housing 10a in a vertically stacked manner. The other two storage parts 12 are disposed side-by-side in the width direction in the housing 10b.

### First Feed Part

The first feed part 14 transports a sheet member P accommodated in a storage part 12 in the housing 10b with multiple transport rollers (not shown) disposed in the housing 10b and feeds the sheet member P to the image forming unit 20 in the housing 10c. The first feed part 14 is an example of a feed part.

### Second Feed Part

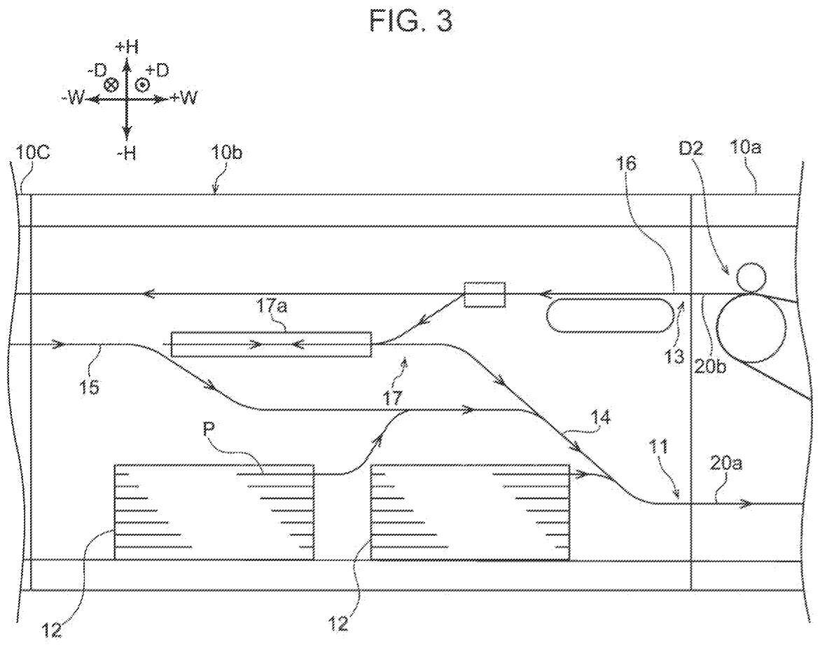

The second feed part 15 transports a sheet member P accommodated in a storage part 12 in the housing 10a with multiple transport rollers (not shown) disposed in the housing 10a and the housing 10b, joins the first feed part 14, and feeds the sheet member P to the image forming unit 20 in the housing 10c. The second feed part 15 is an example of another feed part. As shown in FIG. 3, the second feed part 15 passes between the branch part 17 (described below) and the storage parts 12 in the vertical direction and joins the first feed part 14. In other words, the second feed part 15 is disposed below the branch part 17.

### Image Forming Unit

The image forming unit 20 is disposed in the housing 10c and electrophotographically forms an image on a sheet member P. The image forming unit 20 includes the forming part 22 that forms a toner image on a sheet member P, a fixing part 40 that fixes the toner image formed on the sheet member P to the sheet member P, and a chain gripper 50 that transports the sheet member P from the forming part 22 toward the fixing part 40. The image forming unit 20 also includes a first transport part 20a that transports the sheet member P supplied from the feed part 14 to the housing 10c toward a receiving position D1 (described in detail below), at which the chain gripper 50 receives the sheet member P, in a direction parallel to the width direction (horizontal direction). The image forming unit 20 also includes a second transport part 20b that transports the sheet member P to which the toner image has been fixed in the fixing part 40 toward the discharge part 16 in the housing 10b in the direction parallel to the width direction (horizontal direction).

The first transport part 20a and the second transport part 20b each include multiple transport rollers (not shown). The first transport part 20a is connected to the first feed part 14. The second transport part 20b is connected to the discharge part 16. The connecting part between the first transport part 20a and the first feed part 14 is a connecting part 11, and the connecting part between the second transport part 20b and the discharge part 16 is a connecting part 13.

The first transport part 20a is disposed at the lower side of the housing 10c. More specifically, the first transport part 20a is disposed to the −H side of the center line between the upper surface and the lower surface of the housing 10c. More specifically, the first transport part 20a is disposed at a position within one third of the distance between the upper surface and the lower surface of the housing 10c, to the +H side of the lower surface of the housing 10c.

The second transport part 20b is disposed at the upper side of the housing 10c. More specifically, the second transport part 20b is disposed to the +H side of the center line between the upper surface and the lower surface of the housing 10c. More specifically, the first transport part 20a is disposed at a position within one third of the distance between the upper surface and the lower surface of the housing 10c, to the −H side of the upper surface of the housing 10c.

The forming part 22 includes photoconductor units 23 that form toner images, and a transfer device 30 that transfers the toner images formed in the photoconductor units 23 to a sheet member P.

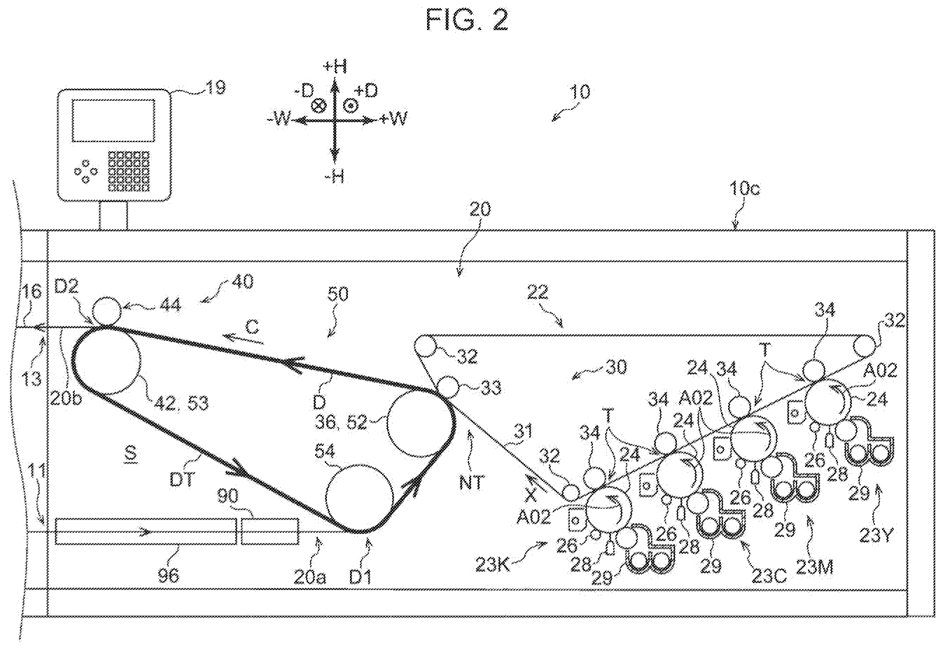

There are multiple photoconductor units 23 so as to form toner images of different colors. In this exemplary embodiment, a total of four photoconductor units 23, which correspond to yellow (Y), magenta (M), cyan (C), and black (K), are provided. The letters Y, M, C, and K shown in FIGS. 1 and 2 are suffixed to the components corresponding to these colors. When there is no need to distinguish between the colors Y, M, C, and K, these letters are omitted.

### Photoconductor Unit

The photoconductor units 23Y, 23M, 23C, and 23K have basically the same configuration except for the toners used.

As shown in FIG. 1, the photoconductor units 23Y, 23M, 23C, and 23K are arranged in a line along an inclined portion of the transfer belt 31 (described in detail below) of the transfer device 30.

As shown in FIG. 2, each photoconductor unit 23 includes a photoconductor drum 24 that rotates in the direction of arrow A02, and a charger 26 that charges the photoconductor drum 24. The photoconductor unit 23 further includes an exposure device 28 that exposes the photoconductor drum 21 charged by the charger 26 to form an electrostatic latent image, and a developing device 29 that develops the electrostatic latent image with toner to form a toner image.

### Transfer Device

The transfer device 30 first-transfers, in a superposed manner, the toner images formed on the photoconductor drums 24 corresponding to the respective colors to the intermediate transfer body and then second-transfers the superposed toner images to a sheet member P. More specifically, as shown in FIG. 2, the transfer device 30 includes: the transfer belt 31, serving as an intermediate transfer body; multiple rollers 32; first transfer rollers 34; a second transfer roller 33; and a transfer body 36.

The transfer belt 31 is an endless belt stretched over the multiple rollers 32 in a substantially inverted triangular orientation. Among the multiple rollers 32 holding the transfer belt 31 in a substantially inverted triangular orientation, the roller 32 on the −W side and the roller 32 on the −H side are a roller 32a and a roller 32b, respectively. The transfer belt 31 revolves in the direction of arrow X when at least one of the multiple rollers 32 is rotationally driven.

The first transfer rollers 34 are opposed to the photoconductor drums 24 corresponding to the respective colors with the transfer belt 31 therebetween. The first transfer rollers 34 transfer the toner images formed on the photoconductor drums 24 to the transfer belt 31 at first transfer positions T between the photoconductor drums 24 and the first transfer rollers 34.

The second transfer roller 33 is disposed on the inner side of the transfer belt 31 so as to be in contact with the transfer belt 31 at a position between the roller 32a and the roller 32b among the rollers 32 over which the transfer belt 31 is stretched in a substantially inverted triangular shape. The transfer body 36 extends in the depth direction and is opposed to the second transfer roller 33 with the transfer belt 31 therebetween. The second transfer roller 33 and the transfer body 36 transfer the toner image transferred to the transfer belt 31 to the sheet member P at a second transfer position NT between the transfer belt 31 and the transfer body 36.

### Chain Gripper

The chain gripper 50 includes a pair of chains 51, leading-end holding parts 55 that hold the leading ends of sheet members P, and pairs of sprockets 52, 53, and 54. The chains 51 are an example of a revolving member. The sprockets 52, 53, and 54 are an example of rotary members. The chain gripper 50 is an example of a revolving part.

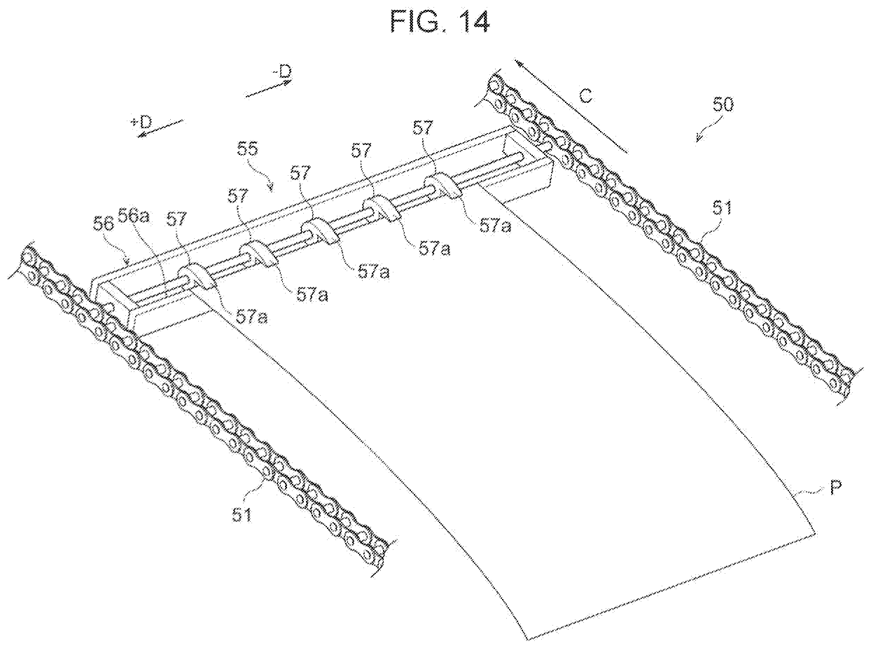

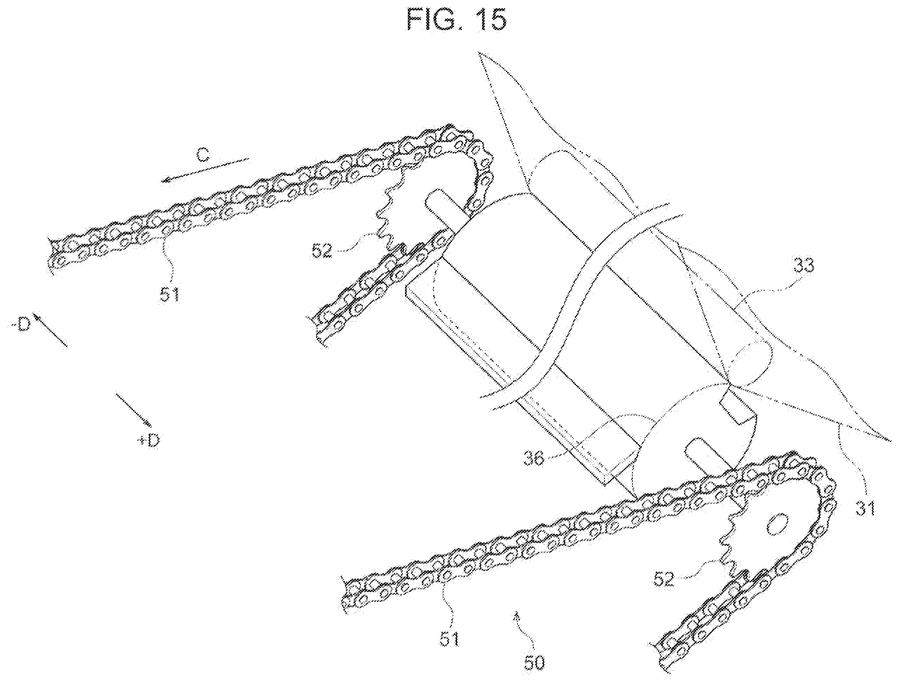

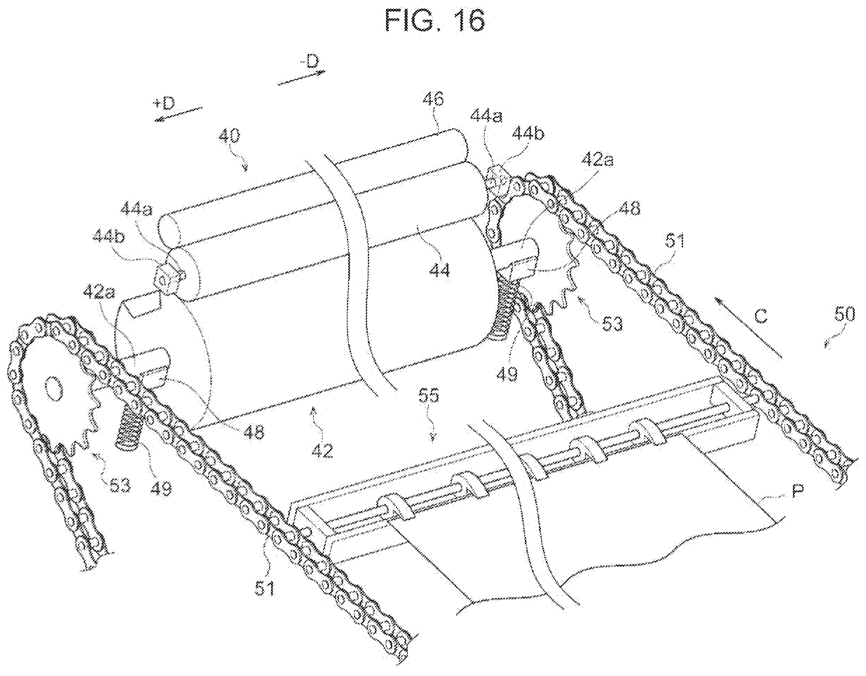

As shown in FIG. 14, the chains 51 are endless chains disposed at a distance from each other in the depth direction. As shown in FIG. 15, the chains 51 are stretched over the pair of sprockets 52 disposed at the ends of the transfer body 36 in the longitudinal direction (axial direction). The axial direction of the sprockets 52 is parallel to the longitudinal direction. The chains 51 are also stretched over the pair of sprockets 53 (see FIG. 16) disposed at the ends of a pressure roller 42 (described below) in the longitudinal direction (axial direction). The axial direction of the sprockets 53 is parallel to the longitudinal direction. As shown in FIG. 2, the chains 51 are also stretched over the pair of sprockets 54 disposed at a distance from each other in the depth direction.

The sprockets 53 disposed at the ends of the pressure roller 42 in the longitudinal direction are disposed to the −W side and to the +H side of the sprockets 52 disposed at the ends of the transfer body 36 in the longitudinal direction.

As viewed in the depth direction, the pair of sprockets 54 are disposed below the sprockets 52 and 53, to the −W side of the sprockets 52 and to the +W side of the sprockets 53. A transport roller (not shown) is disposed between the pair of sprockets 54 so as to be coaxial with the sprockets 54.

As shown in FIG. 14, each leading-end holding part 55 includes an attachment member 56 extending in the depth direction, and grippers 57 attached to the attachment member 56. The ends of the leading-end holding part 55 in the depth direction are attached to the chains 51.

The leading-end holding parts 55 are disposed at predetermined intervals in the circumferential direction (revolving direction) of the chains 51.

The grippers 57 are attached to the attachment member 56 at predetermined intervals in the depth direction. The grippers 57 hold the leading end of a sheet member P. More specifically, the grippers 57 have jaws 57a. The attachment member 56 has a contact part 56a with which the jaws 57a come into contact.

The grippers 57 hold a sheet member P by pinching the leading end of the sheet member P between the jaws 57a and the contact part 56a. In the grippers 57, for example, the jaws 57a are pressed against the contact part 56a by springs or the like, and the jaws 57a are brought toward and away from the contact part 56a by the effect of the cams or the like.

In this configuration, when a rotational force is transmitted to any one of the multiple sprockets 52, 53, and 54 shown in FIG. 2, the pair of chains 51 revolve in the direction of arrow C in FIG. 2 so as to move from the sprockets 52 side toward the sprockets 53 side.

Furthermore, when a leading-end holding part 55 attached to the chains 51 reaches the receiving position D1 at the bottom of the sprockets 54, the grippers 57 of the leading-end holding part 55 pinch the leading end of a sheet member P transported along the first feed part 14 and the first transport part 20a, thus holding and receiving the sheet member P. The chains 51 revolving in the direction of arrow C transport the sheet member P held by the leading-end holding part 55 to the second transfer position NT, where a toner image is transferred to the sheet member P. Furthermore, the revolving chains 51 transport the sheet member P from the second transfer position NT to the fixing part 40, where the toner image is fixed to the sheet member P. At a feed-out position D2 located downstream of the fixing part 40 in the sheet transport direction, the leading-end holding part 55 releases the leading end of the sheet member P after passing through the fixing part 40, and the chain gripper 50 feeds the sheet member P to the second transport part 20b and the discharge part 16.

A portion of the path of the revolving chain gripper 50 between the point after the fixing part 40 (feed-out position D2) and the point after the meeting point with the first transport part 20a (receiving position D1) is inclined downward. This downwardly inclined path extending from the feed-out position D2 to the receiving position D1 is an inclined portion DT. With this configuration, a space S is formed between the inclined portion DT and the first transport part 20a. In this exemplary embodiment, the height of the space S in the vertical direction decreases from the feed-out position D2 side toward the receiving position D1 side in the horizontal direction. In other words, in this exemplary embodiment, the height of the space S in the vertical direction decreases from the fixing part 40 side toward the second transfer position NT side in the horizontal direction.

### Fixing Part

As shown in FIG. 2, the fixing part 40 is disposed downstream of the transfer body 36 in the sheet transport direction.

As shown in FIG. 16, the fixing part 40 includes a heating roller 44 that comes into contact with and heats a sheet member P that is being transported, a pressure roller 42 that presses the sheet member P against the heating roller 44, and a driven roller 46 that is rotated by the heating roller 44.

The heating roller 44 comes into contact with the upper side of the sheet member P that is being transported. The heating roller 44 extends in the depth direction such that the axial direction thereof is parallel to the depth direction. The heating roller 44 has, at the ends thereof in the depth direction, shafts 44a extending in the depth direction and support members 44b for supporting the shafts 44a.

The driven roller 46 is disposed on the opposite side of the heating roller 44 from the sheet member P that is being transported, and extends in the depth direction such that the axial direction thereof is parallel to the depth direction. The driven roller 46 has a heater (not shown). In this configuration, the driven roller 46 is rotated by the heating roller 44. The driven roller 46 heats the heating roller 44.

The pressure roller 42 is opposed to the heating roller 44 with the sheet member P that is being transported therebetween. The pressure roller 42 comes into contact with the lower side of the sheet member P that is being transported, and extends in the depth direction such that the axial direction thereof is parallel to the depth direction. The pressure roller 42 has, at the ends thereof in the depth direction, shafts 42a extending in the axial direction.

The fixing part 40 also includes support members 48 that support the shafts 42a of the pressure roller 42, and urging members 49 that urge the pressure roller 42 toward the heating roller 44 with the support members 48 therebetween. The support members 48 are disposed so as to support the shafts 42a of the pressure roller 42 from below in a manner allowing rotation thereof.

In this configuration, the urging members 49 urge the pressure roller 42 toward the heating roller 44, and the pressure roller 42 presses the sheet member P against the heating roller 44. Furthermore, the pressure roller 42 receives a rotational force transmitted from a driving member (not shown) and rotates. The rotating pressure roller 42 rotates the heating roller 44, and the rotating heating roller 44 rotates the driven roller 46. Furthermore, as a result of the heating roller 44 and the pressure roller 42 nipping and transporting a sheet member P to which a toner image has been transferred, the toner image is heated and fixed to the sheet member P.

### Discharge Part

The discharge part 16 is provided in the housing 10b and discharges, from the discharge port provided in the side surface of the housing 10b on the housing 10a side, a sheet member P transported from the second transport part 20b toward the housing 10b after a toner image has been fixed thereto in the fixing part 40 in the housing 10c.

In this exemplary embodiment, the sheet member P discharged from the discharge port in the housing 10b is passed to an extension discharge part 16a provided in the housing 10a and is discharged on the output part 18 provided outside the housing 10a.

### Branch Part

The branch part 17 is provided so as to be split from the discharge part 16 in the housing 10b and feeds the sheet member P transported to the branch part 17 to the first feed part 14 after switching the leading end and the trailing end of the sheet member P. More specifically, the branch part 17 changes the transport direction of the sheet member P transported from the discharge part 16 to the branch part 17 to the direction opposite to the transport direction in the discharge part 16 on the downstream side of the fixing part 40.

The branch part 17 is disposed above the storage parts 12 and below the discharge part 16 in the housing 10b.

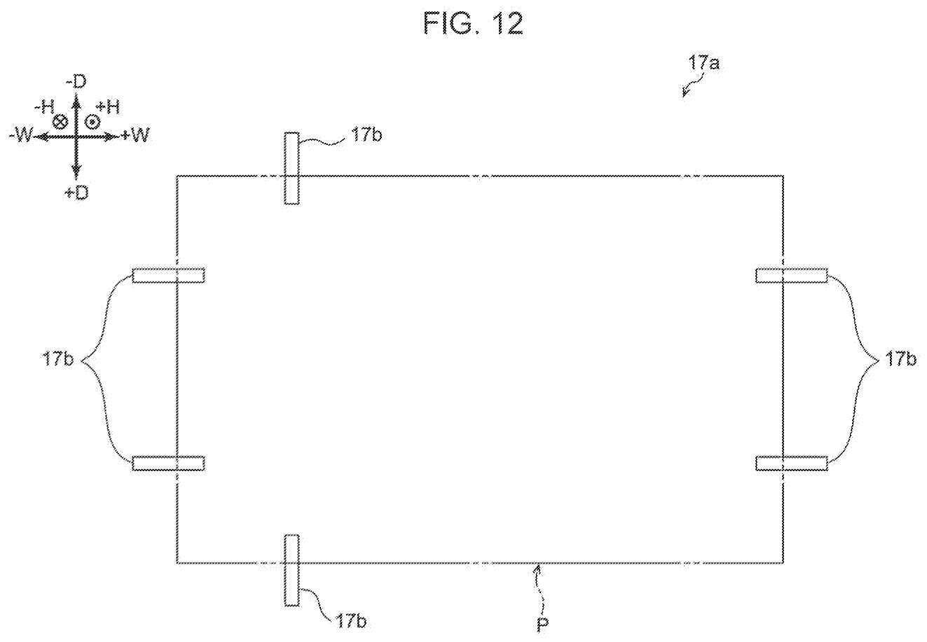

The branch part 17 includes a measurement part 17a that measures the dimensions of the sheet member P transported to the branch part 17. As shown in FIG. 12, the measurement part 17a includes multiple measurement sensors 17b. The measurement part 17a measures the dimensions of the sheet member P to which a toner image has been fixed in the fixing part 40 and which has been transported to the branch part 17 and the dimensions of the image fixed to the sheet member P, and then transmits the measurement results to the controller 19.

The sheet member P transported to the branch part 17 and then fed to the first feed part 14 is transported to the second transfer position NT in a reversed state as compared with the state thereof before being transported to the branch part 17, because the leading end and the trailing end thereof have been switched. More specifically, a sheet member P that is transported to the branch part 17, fed to the first feed part 14, and transported the second transfer position NT receives a toner image on the other side (back surface) of the side (top surface) on which a toner image has been formed before the sheet member P is transported to the branch part 17. At this time, on the basis of the measurement results obtained by the measurement part 17a of the branch part 17, the controller 19 corrects the size of the toner image to be formed on the back of the sheet member P, in accordance with the measured dimensions of the sheet member P and dimensions of the toner image formed on the top surface.

### Position Adjusting Part

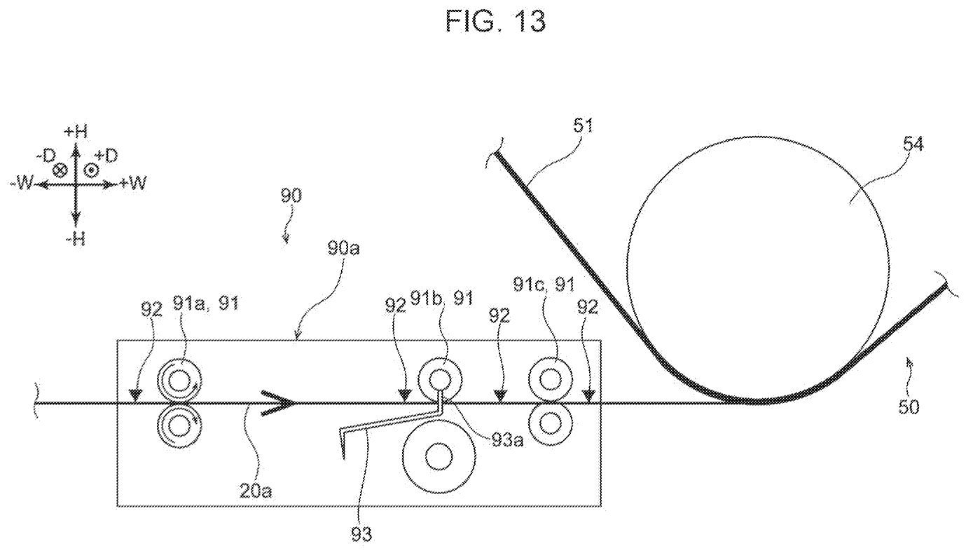

As shown in FIG. 2, the position adjusting part 90 is accommodated in the housing 10c such that an upper portion thereof is located in the space S, and adjusts the position of the sheet member P to be transported to the receiving position D1. As shown in FIG. 13, the position adjusting part 90 includes multiple rollers 91, multiple sensors 92, and a stopper 93.

The multiple rollers 91 are disposed above and below the first transport part 20a so as to form pairs along the first transport part 20a. More specifically, the position adjusting part 90 includes, along the first transport part 20a, roller pairs 91a, 91b, and 91c in this order from the −W side.

The stopper 93 is a substantially N-shaped member, as viewed from the +D side, provided on the roller pair 91b. The downstream end of the stopper 93 in the sheet transport direction is a gate portion 93a standing upright so as to intersect the first transport part 20a. As a result of the leading end of a sheet member P fed to the position adjusting part 90 being butted against the gate portion 93a, the sheet transport timing, misregistration in the sheet width direction, inclination of the sheet member P, and the like are adjusted. In other words, the position adjusting part 90 adjusts the position of the sheet member P to be transported to the receiving position D1 with the gate portion 93a provided on the roller pair 91b.

A lifting member (not shown) including a gear and a motor is provided upstream of the stopper 93 in the sheet transport direction. The stopper 93 moves the gate portion 93a of the stopper 93 up and down with the lifting member.

When the gate portion 93a is moved upward, the gate portion 93a is located at a position where it blocks the first transport part 20a. In this case, a sheet member P transported along the first transport part 20a is stopped at the position of the gate portion 93a. When the gate portion 93a is moved downward, the gate portion 93a is located at a position where it does not block the first transport part 20a. In this case, a sheet member P transported along the first transport part 20a is transported without being interfered by the gate portion 93a.

The multiple sensors 92 detect whether a sheet member P that is being transported along the first transport part 20a has passed or not. Upon receipt of signals from the sensors 92, the controller 19 appropriately controls the operation of the rollers 91 in the position adjusting part 90.

### Measurement Part

The measurement part 96 is disposed along the first transport part 20a, on the upstream side of the position adjusting part 90 in the transport direction and includes multiple sensors (not shown). The measurement part 96 measures the dimensions of a sheet member P transported along the first transport part 20a and transmits the measurement results to the controller 19. On the basis of the measurement results obtained by the measurement part 96, the controller 19 corrects the position of the toner image to be formed on the sheet member P relative to the sheet member P according to the measured dimensions of the sheet member P. The measurement part 96 is an example of another measurement part.

### Housing

The housings 10a, 10b, and 10c each have a rectangular-parallelepiped-shaped frame and walls on the sides of the frame. Of the walls constituting the housings 10a, 10b, and 10c, the walls located on the −W side, +W side, −D side, and +D side are called side walls, and the walls located on the −H side are called bottom walls.

In the housing 10c, the side wall located on the −W side has openings through which the first transport part 20a and the second transport part 20b are connected to the first feed part 14 and the discharge part 16 in the housing 10b at the connecting part 11 and the connecting part 13, respectively.

In the housing 10b, the side wall located on the +W side has openings through which the first feed part 14 and the discharge part 16 are connected to the first transport part 20a and the second transport part 20b in the housing 10c at the connecting part 11 and the connecting part 13, respectively. In the housing 10b, the side wall located on the −W side has openings through which the discharge part 16 and the second feed part 15 are connected to the extension discharge part 16a and the second feed part 15 in the housing 10a, respectively. The housing 10b is an example of a second housing.

In the housing 10a, the side wall located on the +W side has openings through which the extension discharge part 16a and the second feed part 15 are connected to the discharge part 16 and the second feed part 15 in the housing 10b, respectively.

The housings 10a, 10b, and 10c each have, on the bottom-side frame thereof, multiple extendable legs (not shown), so that the height thereof in the vertical direction can be changed. The positions of the housings 10a, 10b, and 10c in the vertical direction can be changed by extending or contracting the legs in the vertical direction.

### First Joint Part and Second Joint Part

The first joint parts 70 and the second joint parts 80 have basically the same structure, except for the objects they join. Hence, the structure of the second joint parts 80 will be described as an example.

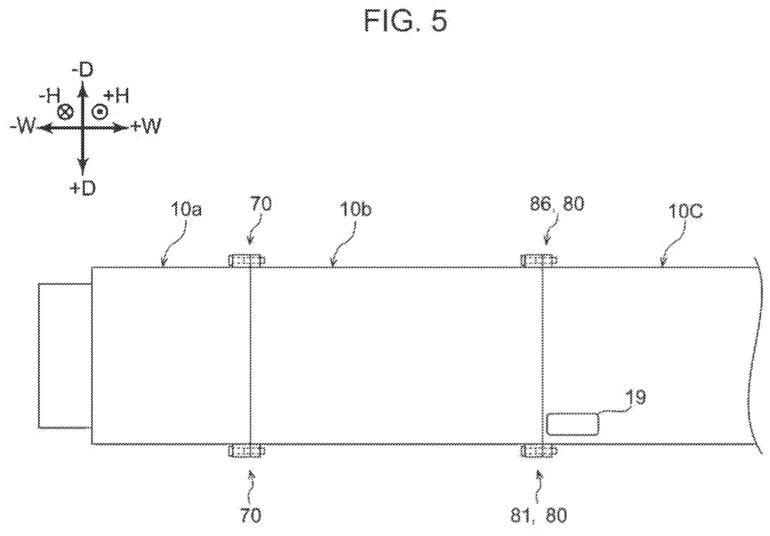

As shown in FIG. 5, the second joint parts 80 are provided on both side walls in the depth direction, at the boundary between the housing 10b and the housing 10c, to join the housing 10b and the housing 10c together. As shown in FIG. 4, the second joint parts 80 are disposed to the −H side of the center line of the housing 10b and the housing 10c in the vertical direction. More specifically, the second joint parts 80 are disposed at the lower side of the housing 10b and the housing 10c. In other words, the second joint parts 80 are disposed at a position closer to the connecting part 11 between the feed part 14 and the first transport part 20a than to the connecting part 13 between the second transport part 20b and the discharge part 16.

As shown in FIG. 5, the second joint parts 80 include a block part 81 provided on the +D-side side walls of the housing 10b and the housing 10c and a block part 86 provided on the −D-side side walls of the housing 10b and the housing 10c. More specifically, the block part 81 and the block part 86 form a pair. The block part 81 and the block part 86 are an example of a joint part.

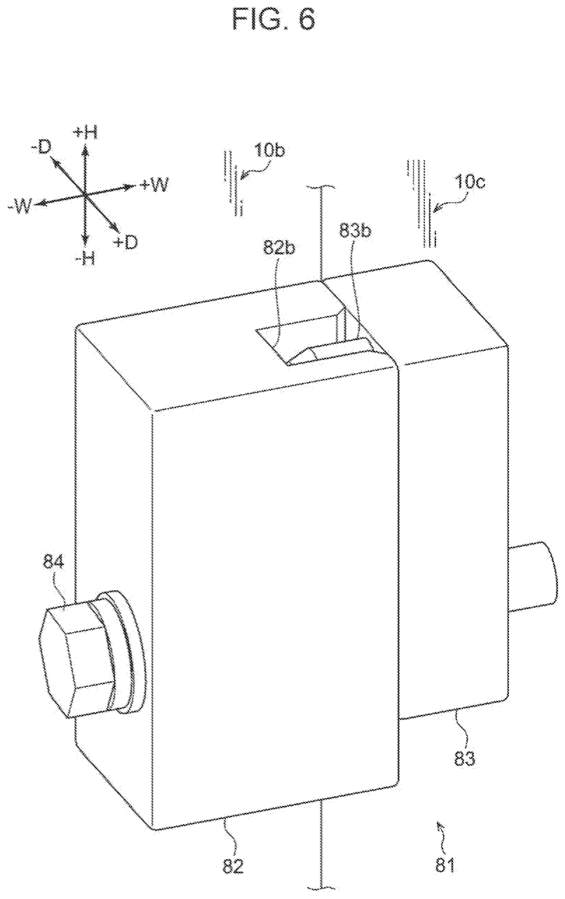

As shown in FIG. 6, the block part 81 includes a block 82 provided on the housing 10b, a block 83 provided on the housing 10c, and a bolt 84 that fastens the block 82 and the block 83 together.

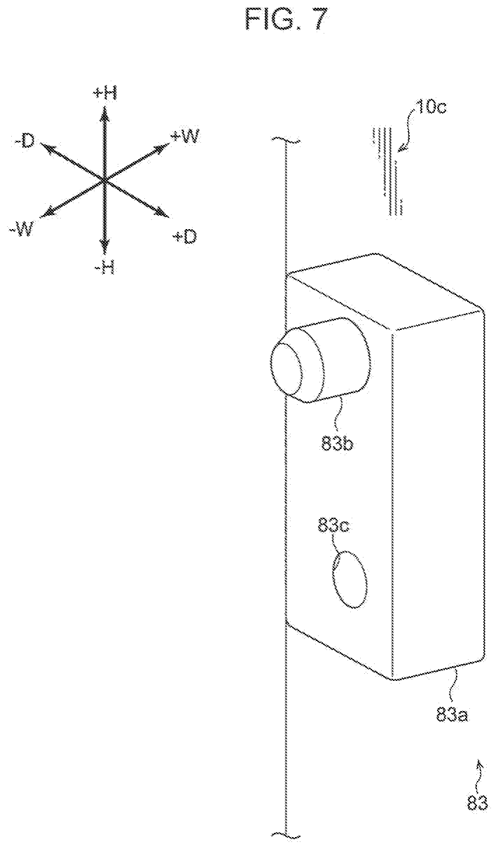

As shown in FIG. 7, the block 83 includes a rectangular-parallelepiped-shaped body 83a and a substantially cylindrical positioning pin 83b projecting to the −W side from the upper side of the −W-side end face of the body 83a. The positioning pin 83b is an example of a projecting portion. The block 83 also has a screw hole 83c penetrating through the body 83a in the width direction, at a position to the −H side of the positioning pin 83b, for receiving the bolt 84. The body 83a is disposed so as to cover the first feed part 14 in the housing 10b in the vertical direction. In other words, the position of the body 83a overlaps the first feed part 14 in the vertical direction. As shown in FIG. 4, the positioning pin 83b is formed to the +H side of the first transport part 20a in the housing 10c. The screw hole 83c is formed to the −H side of the first transport part 20a in the housing 10c.

The positioning pin 83b has a tapered face formed by chamfering the edge of the distal end thereof.

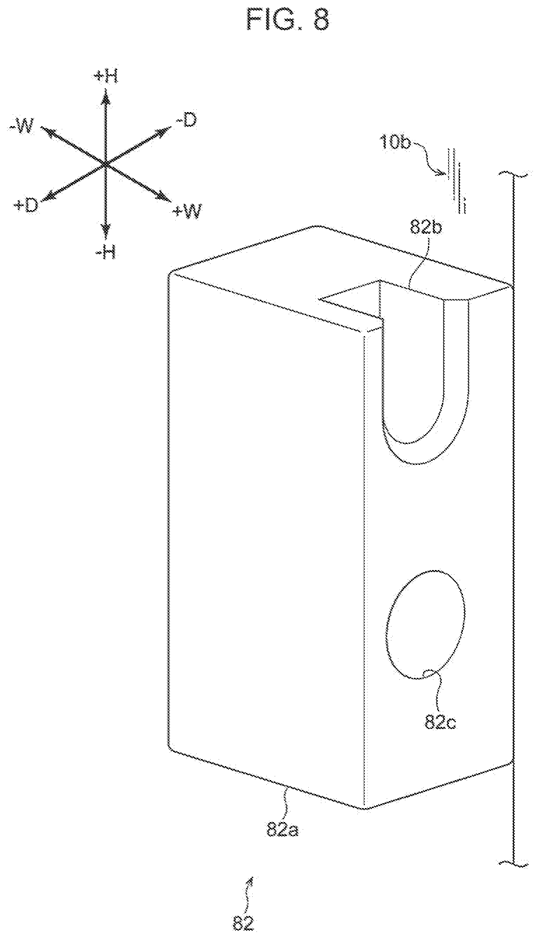

As shown in FIG. 8, the block 82 has a rectangular-parallelepiped-shaped body 82a. The body 82a has a recess 82b provided in an upper portion of the +W-side end face of the body 82a, and a through-hole 82c penetrating through the body 82a in the width direction, at a position corresponding to the screw hole 83c in the block 83, for receiving the bolt 84. The body 82a is disposed so as to cover the first transport part 20a in the housing 10c in the vertical direction. In other words, the position of the body 82a overlaps the first transport part 20a in the vertical direction. The recess 82b is sized such that it can receive the positioning pin 83b of the block 83. The recess 82b is an example of a receiving portion. The dimension of the recess 82b in the depth direction is larger than the dimension of the positioning pin 83b of the block 83 in the depth direction, such that the positioning pin 83b is loosely fitted to the recess 82b. The recess 82b has an open-top groove shape extending from the +H-side end face of the block 82 toward the −H side. The recess 82b is formed to the +H side of the first feed part 14 in the housing 10b. The through-hole 82c is formed to the −H side of the first feed part 14 in the housing 10b.

The recess 82b has a tapered face formed by chamfering the +W-side edge thereof. The tapered face of the recess 82b guides the positioning pin 83b on the housing 10c, which is to be inserted into the recess 82b, into the recess 82b.

The block part 86 is symmetrical to the block part 81 in the depth direction, except that the block part 86 does not have the positioning pin 83b and the recess 82b provided in the block part 81. In other words, in the second joint part 80, the positioning pin 83b and the recess 82b are provided only on the block part 81, which is located on the +D side.

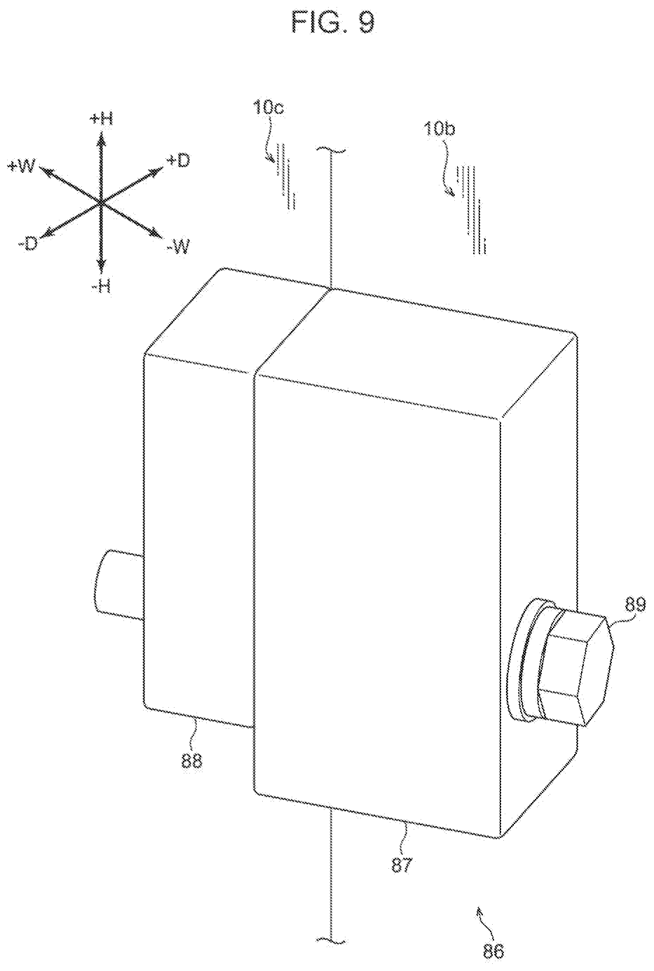

More specifically, as shown in FIG. 9, the block part 86 includes a block 87, a block 88, and a bolt 89, instead of the block 82, the block 83, and the bolt 84 in the block part 81. The position of the block part 86 in the vertical direction is the same as that of the block part 81. Specifically, the position of the block part 86 overlaps the first transport part 20a (connecting part 11) in the vertical direction.

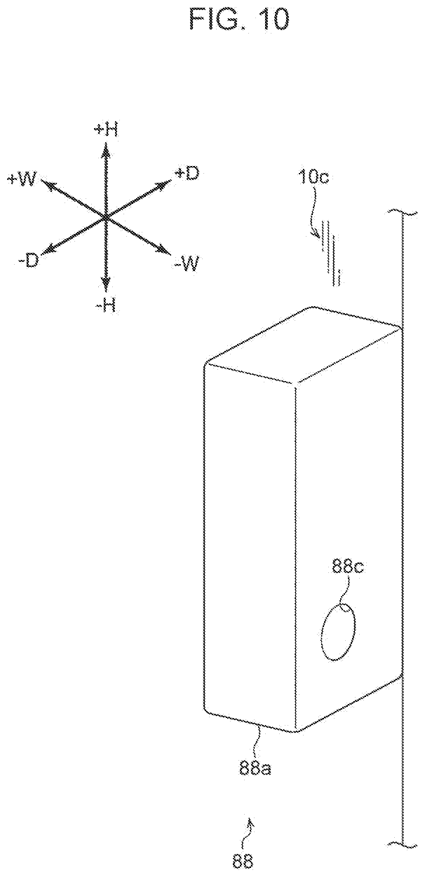

As shown in FIG. 10, the block 88 has a screw hole 88c, instead of the screw hole 83c in the block 83. The −W-side end face of the block 88 is flat, except for the screw hole 88c.

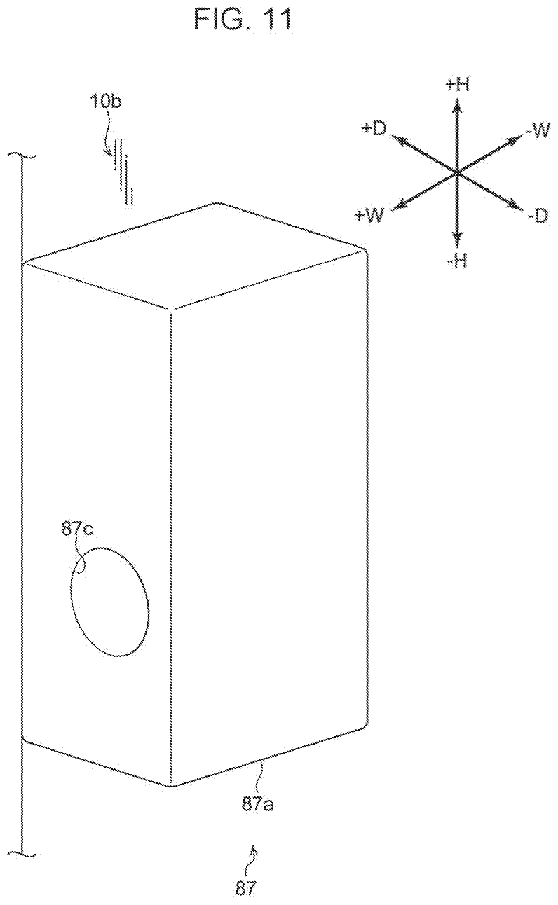

As shown in FIG. 11, the block 87 has a through-hole 87c, instead of the through-hole 82c in the block 82. The +W-side end face of the block 87 is flat, except for the through-hole 87c.

When the surface of the block 82 and the surface of the block 83 facing each other and the surface of the block 87 and the surface of the block 88 facing each other are brought into contact with each other in the width direction, the +W-side side wall of the housing 10b and the −W-side side wall of the housing 10c face each other at a predetermined distance from each other. More specifically, when the surface of the block 82 and the surface of the block 83 facing each other and the surface of the block 87 and the surface of the block 88 facing each other are brought into contact with each other in the width direction, the housing 10b and the housing 10c are positioned with respect to each other in the width direction. In other words, when the surface of the block 82 and the surface of the block 83 facing each other and the surface of the block 87 and the surface of the block 88 facing each other are brought into contact with each other in the width direction, the first feed part 14 and the first transport part 20a are positioned with respect to each other in the width direction.

Furthermore, when the +H-side end faces of the block 82 and the block 83 and the +H-side end faces of the block 87 and the block 88 are in flush with each other, the positions of the first feed part 14 and the first transport part 20a in the vertical direction are aligned. More specifically, when the +H-side end faces of the block 82 and the block 83 and the +H-side end faces of the block 87 and the block 88 are in flush with each other, the first feed part 14 and the first transport part 20a are positioned with respect to each other in the vertical direction. Note that “in flush with each other” means that two surfaces are located within an area of −0.2 mm to +0.2 mm in the vertical direction from a predetermined height position in the vertical direction.

Furthermore, when the entirety of the positioning pin 83b of the block 83 is inserted into the recess 82b in the block 82, the positions of the first feed part 14 and the first transport part 20a in the depth direction are aligned. Specifically, when the entirety of the positioning pin 83b of the block 83 is inserted into the recess 82b in the block 82, the first feed part 14 and the first transport part 20a are positioned with respect to each other in the depth direction. The combination of the positioning pin 83b and the recess 82b is an example of a positioning part.

As a result of the first feed part 14 and the first transport part 20a being positioned with respect to each other by the blocks 82 and 83 this way, the first feed part 14 and the first transport part 20a are connected to each other. Furthermore, the housing 10b and the housing 10c are positioned with respect to each other by the blocks 82 and 83. After the first feed part 14 and the first transport part 20a are positioned with respect to each other, the bolt 84 is screwed into the through-hole 82c and the screw hole 83c, and the bolt 89 is screwed into the through-hole 87c and the screw hole 88c to fix the housing 10b and the housing 10c to each other. The combinations of the bolts 84 and 89, the through-holes 82c and 87c, and the screw holes 83c and 88c are an example of a fixing part.

When the housing 10b and the housing 10c are positioned with respect to each other and fixed to each other, the positions of the block parts 81 and 86 overlap the connecting part 11 between the first feed part 14 and the first transport part 20a in the vertical direction. Furthermore, when the housing 10b and the housing 10c are positioned with respect to each other and fixed to each other, the connecting part 11 between the first feed part 14 and the first transport part 20a is located between the recess 82b and the bolt 84 in the vertical direction.

The first joint parts 70 have the same configuration as the second joint parts 80, except that, as shown in FIGS. 4 and 5, the first joint parts 70 are provided on both side walls in the depth direction, at the boundary between the housing 10a and the housing 10b, to join the housing 10a and the housing 10b together. Furthermore, the first joint parts 70 are disposed to the −H side of the center line of the housing 10a and the housing 10b in the vertical direction. In other words, the first joint parts 70 are disposed on the lower side of the housing 10a and the housing 10b.

### Other Configurations

When positioning the housings 10a, 10b, and 10c with respect to one another in the vertical direction, the vertical positions thereof are adjusted by extending or contracting the multiple legs (not shown) to make the +H-side end faces of the block 82 and the block 83 flush with each other. The +H-side end faces of the block 87 and the block 88 and the +H-side end faces of the opposed blocks in the first joint parts 70 are also made flush with each other in this way.

### Effect and Advantages

Next, effects and advantages of the exemplary embodiment will be described. When a comparative example to the exemplary embodiment will be described below, the same reference signs and names will be used for the same components as those of the image forming apparatus 10 according to the exemplary embodiment.

In the image forming apparatus 10 according to the exemplary embodiment, the image forming unit 20 is disposed in the housing 10c. Specifically, in the image forming apparatus 10 according to the exemplary embodiment, the housing 10c accommodates the forming part 22, the fixing part 40, and the chain gripper 50.

In the image forming apparatus 10, when a toner image is to be formed on a sheet member P, first, a sheet member P stored in a storage part 12 is transported to the receiving position D1, where the chain gripper 50 receives the sheet member P, with the first feed part 14 and the first transport part 20a. Next, the sheet member P transported to the receiving position D1 is held by the chain gripper 50 and is transported to the second transfer position NT, where a toner image formed in the forming part 22 is transferred (formed). The sheet member P to which the toner image has been transferred at the second transfer position NT is then transported to the fixing part 40 while still being held by the chain gripper 50, and the toner image is fixed to the sheet member P. The sheet member P to which the toner image has been fixed in the fixing part 40 is then transported to the second transport part 20b and the discharge part 16. In simplex printing, the sheet member P transported along the second transport part 20b and the discharge part 16 is further transported along the extension discharge part 16a and is discharged onto the output part 18. In duplex printing, the sheet member P transported along the second transport part 20b and the discharge part 16 is transported to the branch part 17, where the leading end and the trailing end of the sheet member P are switched, and is then fed to the first feed part 14 so as to be transported again to the receiving position D1 and the second transfer position NT.

As described, when a toner image is to be formed on a sheet member P with the image forming apparatus 10, the sheet member P is transported to the respective parts of the image forming apparatus 10. Hence, the sheet transport accuracy needs to be adjusted at the time of installing the image forming apparatus 10. In particular, the sheet transport accuracy among the chain gripper 50, the forming part 22, and the fixing part 40 needs to be adjusted so that the toner image formed on the sheet member P does not deviate from the position set by a user. Furthermore, because the image forming apparatus 10 includes multiple housings, the sheet transport accuracy needs to be adjusted across the different housings at the time of installing the image forming apparatus 10.

In the image forming apparatus 10 according to the exemplary embodiment, the forming part 22, the fixing part 40, and the chain gripper 50 are accommodated in a single housing, 10c. Hence, in the image forming apparatus 10, the sheet transport accuracy among the forming part 22, the fixing part 40, and the chain gripper 50 does not need to be adjusted across the different housings at the time of installing the image forming apparatus 10.

Furthermore, in the image forming apparatus 10 according to the exemplary embodiment, the second joint parts 80 are disposed at positions closer to the connecting part 11 between the first feed part 14 and the first transport part 20a than to the connecting part 13 between the second transport part 20b and the discharge part 16.

Furthermore, in the image forming apparatus 10 according to the exemplary embodiment, the second joint parts 80 are disposed at the lower side of the housing 10b and the housing 10c.

Furthermore, in the image forming apparatus 10 according to the exemplary embodiment, the position of the second joint parts 80 in the vertical direction overlaps the connecting part 11 between the first feed part 14 and the first transport part 20a.

Furthermore, in the image forming apparatus 10 according to the exemplary embodiment, the connecting part 11 between the first feed part 14 and the first transport part 20a is located between the recess 82b and the bolt 84 in the vertical direction.

Furthermore, in the image forming apparatus 10 according to the exemplary embodiment, the block part 81 and the block part 86 are provided on both side walls of the housing 10b and the housing 10c in the depth direction.

Furthermore, in the image forming apparatus 10 according to the exemplary embodiment, the top of the recess 82b in the block 82 is open.

Furthermore, in the image forming apparatus 10 according to the exemplary embodiment, in the second joint parts 80, only the block part 81 has the recess 82b and the positioning pin 83b. The image forming apparatus 10 according to the exemplary embodiment and an image forming apparatus 210 according to a comparative example will be compared below.

In the image forming apparatus 210, the recess 82b and the positioning pin 83b are provided both in the block part 81 and the block part 86. Except for this point, the image forming apparatus 210 according to the comparative example has the same configuration as the image forming apparatus 10 according to the exemplary embodiment.

In the image forming apparatus 210 according to the comparative example, when the housing 10b and the housing 10c are positioned with respect to each other and joined together, both of the positioning pin 83b of the block part 81 and the positioning pin 83b of the block part 86 need to be inserted into the recesses 82b.

In contrast, in the image forming apparatus 10 according to the exemplary embodiment, only the block part 81 of the second joint parts 80 has the recess 82b and the positioning pin 83b. Hence, in the image forming apparatus 10 according to the exemplary embodiment, when the housing 10b and the housing 10c are positioned with respect to each other and joined together, only the positioning pin 83b on the block part 81, among the block part 81 and the block part 86, needs to be inserted into the recess 82b.

Furthermore, in the image forming apparatus 10 according to the exemplary embodiment, the position adjusting part 90 is accommodated in the housing 10c. Hence, in the image forming apparatus 10 according to the exemplary embodiment, the distance between the position adjusting part 90 and the receiving position D1, where the chain gripper 50 receives the sheet member P, is short, compared with a configuration in which the position adjusting part 90 is accommodated in the housing 10b.

Furthermore, in the image forming apparatus 10 according to the exemplary embodiment, unlike a configuration in which the position adjusting part 90 is accommodated in the housing 10b, the sheet transport accuracy between the position adjusting part 90 and the chain gripper 50 does not need to be adjusted across the different housings.

Furthermore, in the image forming apparatus 10 according to the exemplary embodiment, the position adjusting part 90 is disposed in the space S.

Furthermore, in the image forming apparatus 10 according to the exemplary embodiment, the branch part 17 is disposed above the storage parts 12 and below the discharge part 16 in the housing 10b. Specifically, in the image forming apparatus 10 according to the exemplary embodiment, the discharge part 16 is disposed above the branch part 17.

Furthermore, in the image forming apparatus 10 according to the exemplary embodiment, the second feed part 15 is disposed below the branch part 17.

Furthermore, the image forming apparatus 10 according to the exemplary embodiment includes the measurement part 17a of the branch part 17.

Furthermore, the image forming apparatus 10 according to the exemplary embodiment includes the measurement part 96.

Although specific exemplary embodiment of the present disclosure have been described in detail above, the present disclosure is not limited to the above-described exemplary embodiment, and various modifications, changes, improvements are possible within the scope of the technical idea of the present disclosure.

For example, the image forming apparatus 10 includes the chain gripper 50 as the revolving part. However, the image forming apparatus according to the present disclosure may include, instead of the chain gripper 50, a transport belt that transports a sheet member P with a revolving belt body stretched over multiple rollers. The rollers of the transport belt are an example of rotary members. The belt body of the transport belt is an example of a revolving member. The transport belt is an example of a revolving part.

Furthermore, the image forming apparatus 10 includes the fixing part 40 including the heating roller 44 and the pressure roller 42. However, the fixing part according to the present disclosure may include a non-contact heating member, such as an infrared heating member.

Furthermore, the image forming apparatus 10 is an electrophotographic image forming apparatus. However, the image forming apparatus 10 according to the present disclosure may be, for example, an ink jet image forming apparatus or an offset image forming apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
a forming part that forms an image on a recording medium;
a fixing part that fixes the image formed on the recording medium;
a revolving part having a revolving member stretched over multiple rotary members, the revolving member revolving between the forming part and the fixing part to transport the recording medium from the forming part to the fixing part;
a feed part that feeds the recording medium to the forming part;
a discharge part that discharges the recording medium to which the image has been fixed in the fixing part;
a branch part that is provided so as to be split from the discharge part and along which the recording medium, to one side of which the image has been fixed, is transported to the feed part after switching the leading end and the trailing end of the recording medium;
a first housing accommodating the forming part, the fixing part, and the revolving part; and
a second housing connected to the first housing and accommodating the feed part, the discharge part, and the branch part.

2. The image forming apparatus according to claim 1, further comprising:
a first transport part that is accommodated in the first housing and transports the recording medium fed from the feed part to the forming part;
a second transport part that is accommodated in the first housing and transports the recording medium to which the image has been fixed in the fixing part from the fixing part to the discharge part; and
a joint part that joins the first housing and the second housing together, the joint part being disposed at a position closer to a connecting part between the feed part and the first transport part than to a connecting part between the second transport part and the discharge part.

3. The image forming apparatus according to claim 2, wherein:
the feed part and the first transport part are disposed on the lower side of the first housing and the second housing and transport the recording medium in a direction parallel to the horizontal direction at the connecting part between the feed part and the first transport part, and
the joint part is disposed on the lower side of the first housing and the second housing.

4. The image forming apparatus according to claim 3, wherein the position of the joint part overlaps the connecting part between the feed part and the first transport part in the vertical direction.

5. The image forming apparatus according to claim 4, wherein:
the first housing and the second housing are arranged side-by-side in the horizontal direction,
the joint part includes a positioning part that positions the first housing and the second housing with respect to each other in an intersecting direction intersecting, in the horizontal direction, the direction in which the first housing and the second housing are arranged side-by-side, and a fixing part that fixes the first housing and the second housing to each other at a position away from the positioning part in the vertical direction, and
the connecting part between the feed part and the first transport part is located between the positioning part and the fixing part in the vertical direction.

6. The image forming apparatus according to claim 2, wherein:
the first housing and the second housing are arranged side-by-side in the horizontal direction, and
the joint part is provided on each of side walls in the intersecting direction intersecting, in the horizontal direction, the direction in which the first housing and the second housing are arranged side-by-side.

7. The image forming apparatus according to claim 3, wherein:
the first housing and the second housing are arranged side-by-side in the horizontal direction, and
the joint part is provided on each of side walls in the intersecting direction intersecting, in the horizontal direction, the direction in which the first housing and the second housing are arranged side-by-side.

8. The image forming apparatus according to claim 4, wherein:
the first housing and the second housing are arranged side-by-side in the horizontal direction, and
the joint part is provided on each of side walls in the intersecting direction intersecting, in the horizontal direction, the direction in which the first housing and the second housing are arranged side-by-side.

9. The image forming apparatus according to claim 5, wherein:
the first housing and the second housing are arranged side-by-side in the horizontal direction, and
the joint part is provided on each of side walls in the intersecting direction intersecting, in the horizontal direction, the direction in which the first housing and the second housing are arranged side-by-side.

10. The image forming apparatus according to claim 6, wherein:
the joint parts each include the positioning part that positions the first housing and the second housing with respect to each other in the intersecting direction using a projecting portion projecting in the direction in which the first housing and the second housing are arranged side-by-side, and a receiving portion whose top part is open and into which the projecting portion is inserted.

11. The image forming apparatus according to claim 7, wherein:
the joint parts each include the positioning part that positions the first housing and the second housing with respect to each other in the intersecting direction using a projecting portion projecting in the direction in which the first housing and the second housing are arranged side-by-side, and a receiving portion whose top part is open and into which the projecting portion is inserted.

12. The image forming apparatus according to claim 8, wherein:
the joint parts each include the positioning part that positions the first housing and the second housing with respect to each other in the intersecting direction using a projecting portion projecting in the direction in which the first housing and the second housing are arranged side-by-side, and a receiving portion whose top part is open and into which the projecting portion is inserted.

13. The image forming apparatus according to claim 9, wherein:
the joint parts each include the positioning part that positions the first housing and the second housing with respect to each other in the intersecting direction using a projecting portion projecting in the direction in which the first housing and the second housing are arranged side-by-side, and a receiving portion whose top part is open and into which the projecting portion is inserted.

14. The image forming apparatus according to claim 10, wherein the positioning part is provided only on one of the joint parts.

15. The image forming apparatus according to claim 1, further comprising a position adjusting part that is accommodated in the first housing and adjusts the position of the recording medium to be transported to the forming part.

16. The image forming apparatus according to claim 15, further comprising a first transport part that is accommodated in the lower side of the first housing and transports the recording medium fed from the feed part toward the forming part in the horizontal direction, wherein:
the revolving part is disposed above the first transport part such that a space is formed between the revolving part and the first transport part in the vertical direction, and
the position adjusting part is disposed in the space.

17. The image forming apparatus according to claim 1, wherein:
the branch part is disposed above the feed part, and
the discharge part is disposed above the branch part.

18. The image forming apparatus according to claim 1, further comprising another feed part that is accommodated at a position below the branch part in the second housing, transports a recording medium fed from the outside of the second housing, and joins the feed part.

19. The image forming apparatus according to claim 1, further comprising a measurement part that measures the dimensions of the recording medium transported to the branch part.

20. The image forming apparatus according to claim 1, further comprising another measurement part that is accommodated in the first housing and measures the dimensions of the recording medium transported from the feed part to the forming part.
